(19) United States
(12) Patent Application Publication
(10) Pub. No.: US 2022/0367881 A1
(43) Pub. Date: Nov. 17, 2022

(54) SECONDARY BATTERY ELECTRODE AND NONAQUEOUS ELECTROLYTE SECONDARY BATTERY INCLUDING THE SAME

(71) Applicant: Prime Planet Energy & Solutions, Inc., Tokyo (JP)

(72) Inventor: Shingo KOMURA, Nagakute-shi (JP)

(21) Appl. No.: 17/738,207

(22) Filed: May 6, 2022

(30) Foreign Application Priority Data
May 13, 2021 (JP) 2021-081710

(51) Int. Cl. H01M 4/70; H01M 10/0525; H01M 4/04

(52) U.S. Cl. CPC H01M 4/70; H01M 10/0525; H01M 4/0404; H01M 2004/021

(57) ABSTRACT

A secondary battery electrode disclosed here is a positive electrode or a negative electrode of a secondary battery, and includes a rectangular sheet-like electrode current collector, and an electrode active material layer disposed on the electrode current collector. At least one end portion of the electrode current collector in a long-side direction is provide with an uncoated portion in which the electrode active material layer is not formed. The electrode active material layer has a length L1 of 300 mm or more in the long-side direction, and includes a flat surface portion having a substantially uniform average thickness t₁ and a tilt portion in which the tilt portion having a thickness that continuously decreases toward the uncoated portion. A length L2 from a boundary between the electrode active material layer and the uncoated portion to a point P is 0.5 mm or more and 25 mm or less.

### CROSS REFERENCE TO RELATED APPLICATIONS

This application claims the benefit of priority to Japanese Patent Application No. 2021-081710 filed on May 13, 2021. The entire contents of this application are hereby incorporated herein by reference.

### BACKGROUND

### 1. Technical Field

The present disclosure relates to a secondary battery electrode and a nonaqueous electrolyte secondary battery including the electrode.

### 2. Description of the Background

Secondary batteries such as lithium ion secondary batteries are lightweight and have high energy density as compared to existing batteries, and thus, the secondary batteries are favorably used as high power supplies to be mounted on vehicles and power supplies for personal computers and portable terminals. In particular, lithium ion secondary batteries are favorably used as high power supplies for driving vehicles such as battery electric vehicles (BEV), hybrid electric vehicles (HEV), and plug-in hybrid electric vehicles (PHEV).

In a typical structure of a positive electrode and a negative electrode (hereinafter simply referred to as “electrodes” when positive and negative electrodes are not distinguished) of a secondary battery of this type, an electrode active material layer containing an electrode active material layer as a main component is formed on one or each surface of a rectangular sheet-like electrode current collector. In general, the electrode current collector includes a region where the electrode active material layer is formed (coated portion) and a region located at an end of the electrode current collector in the long-side direction thereof and provided with no electrode active material layer (uncoated portion). The uncoated portion located along the long-side direction of the electrode current collector is connected to an electrode terminal for external connection so that electric power can be supplied to external equipment (e.g., a vehicle).

To stabilize performance and quality of a secondary battery at high level, variations in weight (fabric weight) of the electrode active material layer per a unit area are preferably reduced. That is, the electrode active material layer preferably has a uniform thickness. Japanese Patent Application Publication No. 2015-146232 discloses a method for fabricating an electrode that causes a fabric weight of a coating start portion or a coating termination portion of an active material layer to be close to a reference fabric weight.

### SUMMARY

Recent secondary batteries for battery electric vehicles have been required of further increasing endurance distance, and of being mounted efficiently by, for example, increasing capacity per a unit cell or minimizing a gap (dead space) in limited space. To satisfy these requirements, a study has been made to increase the length in the long-side direction (i.e., obtain a long secondary battery) without a change in the height (i.e., the length in the short-side direction) of the secondary battery, for example.

In a case where the electrode of the long secondary battery is formed to have a uniform thickness of the electrode active material layer as described in Japanese Patent Application Publication No. 2015-146232, current density can vary between a portion (end portion) near the electrode terminal and a center portion of an electrode body. Accordingly, lithium is precipitated in the end portion of the electrode body having a relatively high current density during charging or discharging so that durability (especially a capacity retention rate) of the secondary battery degrades. A result of an intensive study of the inventor of the present disclosure shows that the presence of a thin region of the electrode active material layer in an end portion of the electrode body enables adjustment of a volume ratio of a positive electrode and a negative electrode so that durability can be enhanced. On the other hand, the problem was found that if the thin region is excessively large in area, volumetric efficiency of the secondary battery decreases so that a target energy amount is not satisfied.

It is therefore a main object of the present disclosure to provide an electrode enabling enhancement of durability and volumetric efficiency of a secondary battery. It is another object of the present disclosure to provide a nonaqueous electrolyte secondary battery including such an electrode.

To achieve the objects, a secondary battery electrode disclosed here is provided. A secondary battery electrode disclosed here is a positive electrode or a negative electrode of a secondary battery, and includes: a rectangular sheet-like electrode current collector; and an electrode active material layer disposed on the electrode current collector. At least one end portion of the electrode current collector in a long-side direction is provide with an uncoated portion in which the electrode active material layer is not formed. The electrode active material layer has a length L1 of 300 mm or more in the long-side direction, and includes a flat surface portion having a substantially uniform average thickness t₁ and a tilt portion in which the tilt portion having a thickness that continuously decreases toward the uncoated portion. A length L2 from a boundary between the electrode active material layer and the uncoated portion to a point P is 0.5 mm or more and 25 mm or less, where P is a point at which the thickness of the tilt portion is 0.8 of the average thickness ti of the flat surface portion.

With this configuration, the presence of the relatively long region having a smaller thickness than the flat surface portion in the electrode can suppress capacity degradation due to lithium precipitation and enhance durability (especially capacity retention rate). In addition, volumetric efficiency of the secondary battery can be enhanced by setting the length of the thin region at an appropriate length in the electrode. Thus, it is possible to provide the electrode enabling enhancement of durability and volumetric efficiency of the secondary battery.

In one preferred aspect of the electrode disclosed here, the length L1 of the electrode active material layer in the long-side direction is 600 mm or more and 1400 mm or less.

With this configuration, even a long electrode of 600 mm or more enables enhancement of durability and volumetric efficiency of the secondary battery.

To achieve another object, a nonaqueous electrolyte secondary battery is provided. The nonaqueous electrolyte secondary battery disclosed here includes a positive electrode, a negative electrode, and a nonaqueous electrolyte, and at least one of the positive electrode or the negative electrode is the electrode described above.

With this configuration, the electrode having the characteristics described above enables enhancement of durability and volumetric efficiency of the secondary battery.

### BRIEF DESCRIPTION OF THE DRAWINGS

FIG. 1 is a perspective view schematically illustrating a lithium ion secondary battery according to one preferred embodiment.

FIG. 2 is an illustration schematically showing members constituting a laminated electrode body according to one preferred embodiment.

FIG. 3 is a perspective view schematically illustrating a configuration of a laminated electrode body according to one preferred embodiment.

FIG. 4 is a schematic cross-sectional view for describing an electrode according to one preferred embodiment.

### DETAILED DESCRIPTION

A preferred embodiment of the technique disclosed here will be described hereinafter with reference to the drawings. Matter not specifically mentioned herein but required for carrying out the technique disclosed here (e.g., a general configuration and a fabrication process of a nonaqueous electrolyte secondary battery) can be understood as design matter of those skilled in the art based on related art in the field. The technique disclosed here can be carried out on the basis of the contents disclosed herein and common general knowledge in the field.

The expression “A to B (where A and B are any values)” indicating a numerical range herein includes “A or more and B or less.”

A “secondary battery” herein refers to a storage device enabling repetitive charging and discharging. Typical examples of the secondary battery include a lithium ion secondary battery, a nickel-metal hydride battery, a lithium ion capacitor, and an electric double-layer capacitor. A “lithium ion secondary battery” herein refers to a secondary battery that uses lithium ions as carriers and is charged and discharged by movement of lithium ions between a positive electrode and a negative electrode. In a case where the positive electrode and the negative electrode do not need to be distinguished, the electrodes will be herein simply referred to as electrodes.

Although not intended to be particularly limited, the technique disclosed here will be specifically described hereinafter using a lithium ion secondary battery as an example. In the drawings, members and parts having the same functions are denoted by the same reference characters, and description will not be repeated or will be simplified. Characters X and Y in the drawings refer to a short-side direction and a long-side direction, respectively, of an electrode body. One of the long-side directions Y will also be referred to as a direction Y1 (rightward direction) and the opposite direction will also be referred to as a direction Y2 (leftward direction). It should be noted that these directions are defined merely for convenience of description, and do not limit the state of installation of the lithium ion secondary battery.

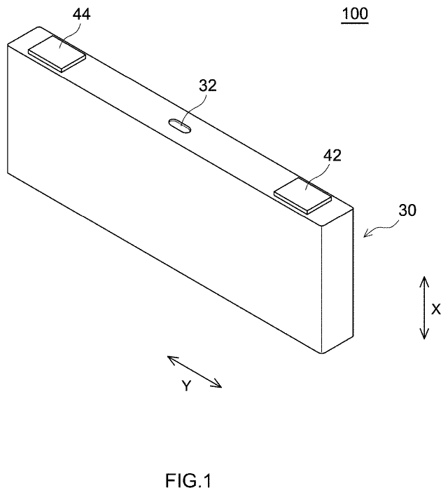

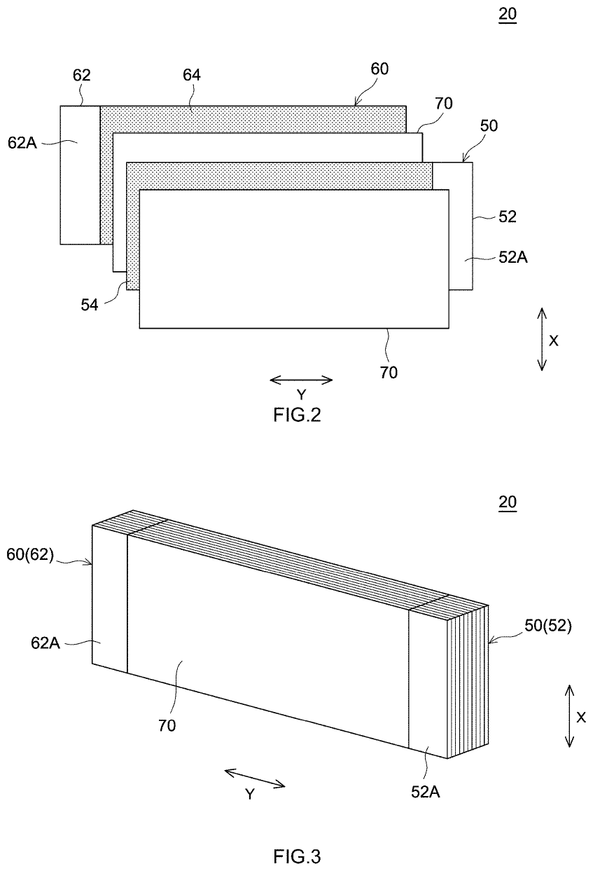

A lithium ion secondary battery 100 illustrated in FIG. 1 is configured such that a rectangular laminated electrode body 20 (see FIGS. 2 and 3) is housed in a box-shaped battery case 30 that can be sealed, together with an unillustrated nonaqueous electrolyte. The battery case 30 is provided with a positive electrode terminal 42 and a negative electrode terminal 44 for external connection, and a thin safety valve 32 configured to release an inner pressure of the battery case 30 when the inner pressure increases to a predetermined level or more. The battery case 30 has an injection port (not shown) for injecting the nonaqueous electrolyte. A material for the battery case 30 is preferably a metal material having high strength, lightweight, and high thermal conductivity. Examples of such a metal material include aluminium and steel.

As illustrated in FIG. 2, the laminated electrode body 20 is formed by alternately stacking a rectangular sheet-like positive electrode (hereinafter referred to as a “positive electrode sheet 50”) and a rectangular sheet-like negative electrode (hereinafter referred to as a “negative electrode sheet 60”) with a rectangular sheet-like separator 70 interposed therebetween. The positive electrode sheet 50 has a configuration in which a positive electrode active material layer 54 is formed on one or each side of a positive electrode current collector 52. The negative electrode sheet 60 has a configuration in which a negative electrode active material layer 64 is formed on one or each side of a long sheet-like negative electrode current collector 62. A positive electrode active material layer uncoated portion 52A not including the positive electrode active material layer 54 in a band shape along a short-side direction (direction X) orthogonal the long-side direction (direction Y) is formed in one end of the rectangular positive electrode current collector 52 in the long-side direction. Similarly, a negative electrode active material layer uncoated portion 62A not including the negative electrode active material layer 64 in a band shape along the short-side direction is formed in the other end of the rectangular negative electrode current collector 62 in the long-side direction.

An aspect ratio (length in long-side direction/length in short-side direction) of the length in the long-side direction to the length in the short-side direction of the lithium ion secondary battery 100 is preferably four or more, for example. The aspect ratio of the secondary battery may be 6 or more, 8 or more, and 10 or more. The upper limit of the aspect ratio of the secondary battery may be, for example, 20 or less, or 18 or less. Since the aspect ratio of the secondary battery is within the range described above, the secondary battery can be efficiently mounted in limited space such as space under the floor or a vehicle, for example.

As illustrated in FIGS. 2 and 3, the positive electrode sheet 50 and the negative electrode sheet 60 are stacked while being slightly shifted from each other in the long-side direction such that the positive electrode active material layer uncoated portion 52A extends off from one end of the separator 70 in the long-side direction and the negative electrode active material layer uncoated portion 62A extends off from the other end. Consequently, as illustrated in FIG. 3, a portion on which the positive electrode active material layer uncoated portion 52A is stacked and a portion on which the negative electrode active material layer uncoated portion 62A is stacked are respectively formed in one end and the other end of the laminated electrode body 20 in the long-side direction. The positive electrode active material layer uncoated portion 52A and the negative electrode active material layer uncoated portion 62A are electrically connected to the positive electrode terminal 42 and the negative electrode terminal 44, respectively. The positive electrode terminal 42 is typically, but is not limited to, made of aluminium, for example. The negative electrode terminal 44 is made of, for example, copper.

In the laminated electrode body 20, the length of the negative electrode active material layer 64 in the long-side direction (direction Y) is preferably larger than the length of the positive electrode active material layer 54 in the long-side direction (direction Y). In this case, when the positive electrode sheet 50 and the negative electrode sheet 60 are overlaid on each other, the negative electrode active material layer 64 includes an opposed portion opposed to the positive electrode active material layer 54, and a non-opposed portion not opposed to the positive electrode active material layer 54. The presence of the non-opposed portion of the negative electrode active material layer 64 can suppress metal precipitation (e.g., lithium precipitation) on the negative electrode. On the other hand, if the non-opposed portion is excessively large, an irreversible capacity might increase, and the capacity retention rate might decrease. In view of this, the difference in the length in the direction Y between the positive electrode active material layer 54 and the negative electrode active material layer 64 (i.e., a phase difference between the positive electrode active material layer 54 and the negative electrode active material layer 64) is preferably about 1 mm to 5 mm (e.g., 1 mm to 3 mm).

The positive electrode sheet 50 includes the positive electrode active material layer 54 on the rectangular positive electrode current collector 52. Examples of the positive electrode current collector 52 include metal materials having high conductivity, such as aluminium, nickel, titanium, and stainless steel. In particular, aluminium (e.g., aluminium foil) is preferable. The thickness of the positive electrode current collector 52 is, but is not limited to, 5 μm or more and 35 μm or less, for example, and is preferably 7 μm or more and 20 μm or less.

The positive electrode active material layer 54 includes at least a positive electrode active material. The positive electrode active material is a compound that can reversibly absorb and desorb chemical species serving as carriers (i.e., lithium ions in a lithium ion secondary battery). The positive electrode active material is not specifically limited, and two or more of positive electrode active materials conventionally typically used for a nonaqueous electrolyte secondary battery, especially a positive electrode active material of a lithium ion secondary battery, can be used. Preferred examples of the positive electrode active material include lithium composite oxide and a lithium transitional metal phosphoric acid compound (e.g., LiFePO₄). Examples of the lithium composite oxide include a lithium nickel-based composite oxide, lithium cobalt-based composite oxide, lithium manganese-based composite oxide, lithium nickel manganese-based composite oxide (e.g., LiNi_{0.5}Mn_{1.5}O₄), and lithium nickel manganese cobalt-based composite oxide (e.g., LiNi_{1/3}Co_{1/3}Mn_{1/3}O₂).

An average particle size of the positive electrode active material may be, but is not limited to, approximately 0.5 μm or more and 50 μm or less, and may be typically 1 μm or more and 20 μm or less. The “average particle size” herein refers to a particle size (D₅₀, also referred to as a median particle size) corresponding to a cumulative frequency of 50 vol. % from a fine particle side having a small particle size, in a particle size distribution of a volume reference based on a typical laser diffraction/light scattering method.

The positive electrode active material layer 54 may include materials other than the positive electrode active material, such as a conductive agent and/or a binder. Preferred examples of the conductive material include carbon black such as acetylene black (AB) and other carbon materials (e.g., graphite).

Preferred examples of the binder include polyvinylidene fluoride (PVdF), polytetrafluoroethylene (PTFE), perfluoroalkoxy alkane (PFA), ethylene tetrafluoroethylene (ETFE) polymer, ethylene chlorotrifluoroethylene (ECTFE) copolymer, polyvinyl alcohol (PVA), and polyethylene oxide (PEO). As a solvent for a positive electrode active material layer paste for forming the positive electrode active material layer 54, a polar nonaqueous solvent (e.g., N-methylpyrrolidone) is used. If affinity (e.g., solubility or dispersibility) of the binder for the polar nonaqueous solvent is excessively low, viscosity design suitable for coating of the positive electrode active material layer paste might be difficult. In view of this, the binder preferably has high affinity for the polar nonaqueous solvent. Examples of such a binder include PVdF.

The “paste” herein includes forms called “slurry” or “ink.”

The negative electrode sheet 60 includes the negative electrode active material layer 64 on the long sheet-like negative electrode current collector 62. The negative electrode current collector 62 is made of, for example, a metal material having high conductivity, such as copper, an alloy mainly containing copper, nickel, titanium, or stainless steel. In particular, copper (e.g., copper foil) is preferably employed. The thickness of the negative electrode current collector 62 may be, for example, approximately 5 μm to 20 μm, and preferably 8 μm to 15 μm.

The negative electrode active material layer 64 includes at least a negative electrode active material. The negative electrode active material is a compound that can reversibly absorb and desorb chemical species serving as carriers (i.e., lithium ions in a lithium ion secondary battery). The negative electrode active material is not specifically limited, and two or more of negative electrode active materials conventionally typically used for a nonaqueous electrolyte secondary battery, especially a negative electrode active material of a lithium ion secondary battery, can be used. Examples of the negative electrode active material include carbon materials such as hard carbon, graphite, and boron-added carbon, and lithium titanate.

The negative electrode active material is typically particulate. An average particle size of the particulate negative electrode active material is not specifically limited, and may be typically 1 μm to 50 μm, and may be, for example, 1 μm to 20 μm.

The negative electrode active material layer 64 may include materials other than the negative electrode active material, such as a conductive material and/or a binder. Examples of the conductive material include carbon black such as acetylene black and Ketjen black, vapor grown carbon fibers (VGCF), and carbon nanotubes. As the binder, styrene-butadiene rubber (SBR) can be used, for example. Other additives such as a thickener, a dispersant, and/or a conductive material may be used as appropriate. As the thickener, carboxymethyl cellulose (CMC) or methyl cellulose (MC) is preferably used, for example. As an example of a solvent included in the negative electrode active material layer paste for forming the negative electrode active material layer 64, an aqueous solvent is preferably used, for example. The aqueous solvent refers to water or a mixed solvent mainly containing water.

A capacity ratio of the positive electrode and the negative electrode may be adjusted based on, for example, a difference in property of receiving charge carriers. Specifically, a ratio (Cₐ/C_{c}) of a negative electrode capacity Cₐ (Ah) to a positive electrode capacity C_{c} (Ah) is appropriately 1.0 to 2.0, and preferably 1.5 to 1.9. The positive electrode capacity C_{c} (Ah) is defined as a product of a theoretical capacity (Ah/g) per a unit mass of a positive electrode active material and a mass (g) of the positive electrode active material. Similarly, the negative electrode capacity Cₐ (Ah) is defined as a product of a theoretical capacity (Ah/g) per a unit mass of the negative electrode active material and a mass (g) of the negative electrode active material.

As the separator 70, materials used in a secondary battery of this type can be used without any particular limitation. Examples of the materials include a porous sheet (film) of a resin such as polyethylene (PE), polypropylene (PP), polyester, cellulose, or polyamide. The porous sheet may have a single-layer structure or two or more layered structure (three-layer structure in which PP layers are stacked on both surfaces of a PE layer). The separator 70 may be provided with a heat-resistant layer (HRL).

The thickness of the separator 70 is not specifically limited, and may be approximately 10 μm or more (typically 15 μm or more, e.g., 20 μm or more), and preferably 100 μm or less (typically 90 μm or less, e.g., 80 μm or less). When the average thickness of the separator 70 is within the range described above, more desirable ion permeability is obtained, and a fine micro short-circuit (current leakage) is less likely to occur. The average pore diameter of the separator 70 is not specifically limited, and may be 0.01 μm or more and 5 μm or less, for example.

A typical nonaqueous electrolyte is a liquid material (nonaqueous electrolyte) in which a supporting electrolyte (e.g., lithium salt, sodium salt, or magnesium salt, and lithium salt in a lithium ion secondary battery) is dissolved or dispersed in a nonaqueous solvent. Alternatively, A solid material (typically, gel) in which polymer is added to a nonaqueous electrolyte may be used.

As the supporting electrolyte, a supporting electrolyte conventionally used for a nonaqueous electrolyte secondary battery of this type can be used without any particular limitation. For example, lithium salt such as LiPF₆, LiBF₄, LiClO₄, LiAsF₆, or Li(C₂F₅SO₂)₂ may be used. In particular, LiPF₆ is preferably used. The concentration of the supporting electrolyte is preferably 0.1 mol/L or more, and preferably 0.5 mol/L or more and 1.5 mol/L or less, for example.

Examples of the nonaqueous solvent include cyclic carbonates such as ethylene carbonate (EC), propylene carbonate (PC), and butylene carbonate, and chain carbonates such as dimethyl carbonate (DMC), methylethyl carbonate (MEC), diethyl carbonate (DEC), methylpropyl carbonate (MPC), and methylbutyl carbonate (MBC). As the nonaqueous solvent, cyclic ester such as γ-butyrolactone, cyclic sulfone such as sulfolane, cyclic ether such as dioxolane, chain carboxylate such as ethyl propionate, or chain ether such as dimethoxyethane may be used, for example. Such nonaqueous solvents may be used alone or two or more of them may be used in combination. In particular, a mixed solvent including cyclic carbonate and chain carbonate is preferably used because an electrolyte having a low viscosity, a high degree of dissociation, and high ion conductivity is obtained.

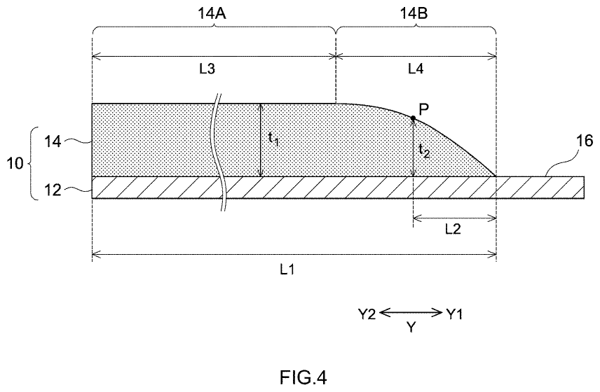

FIG. 4 schematically illustrates a partial cross section of an electrode (positive electrode and/or negative electrode) disclosed here. As illustrated in FIG. 4, an electrode 10 includes an electrode active material layer 14 on an electrode current collector 12. The electrode current collector 12 includes an uncoated portion 16 in which the electrode active material layer 14 is not formed and the current collector is exposed. The electrode active material layer 14 includes a flat surface portion 14A having a substantially uniform average thickness t₁, and a tilt portion 14B whose thickness continuously decreases toward the uncoated portion 16. In FIG. 4, the uncoated portion 16 is formed only in one end in the long-side direction (direction Y1) as an example, but this example is not intended to limit the technique disclosed here.

A length L1 of the electrode active material layer 14 in the long-side direction is at least 300 mm or more. The length L1 of the electrode active material layer 14 in the long-side direction may be, for example, 400 mm or more, 500 mm or more, and 600 mm or more. By increasing the length L1 of the long-side direction (forming a long layer) as described above, capacity per a unit cell can be increased. In addition, the increase in the length of the secondary battery is preferable because the battery can be mounted in limited space such as a vehicle with a smaller gap (dead space) than in a case where a plurality of conventional small batteries are mounted. On the other hand, the upper limit of the length L1 of the electrode active material layer 14 in the long-side direction is appropriately adjusted to design of a product on which the secondary battery is mounted, and may be, for example, 1400 mm or less, and 1300 mm or less. The length L1 of the electrode active material layer in the long-side direction is the sum of a length L3 of the flat surface portion 14A in the long-side direction and a length L4 of the tilt portion 14B in the long-side direction, as illustrated in the drawing.

The flat surface portion 14A of the electrode active material layer 14 typically has a substantially uniform thickness. The flat surface portion 14A is formed on the surface of the electrode current collector 12. The average thickness t₁ of the flat surface portion 14A is not specifically limited, and may be approximately 10 μm to 200 μm, and may be typically 20 μm to 150 μm, and may be, for example, 40 μm to 100 μm.

The flat surface portion 14A here includes the center of the electrode active material layer 14 in the long-side direction. The flat surface portion 14A has the length L3 in the long-side direction. The length L3 of the flat surface portion 14A in the long-side direction is appropriately set such that the length L1 of the electrode active material layer 14 in the long-side direction is 300 mm or more and 1400 mm or less. For example, the length L3 of the fiat surface portion 14A in the lone-side direction may be about 260 mm or more and 1360 mm or less.

The tilt portion 14B of the electrode active material layer 14 extends from the flat surface portion 14A. The thickness of the tilt portion 14B typically continuously decreases toward the uncoated portion 16 (i.e., the end portion of the electrode current collector 12 in the direction Y1). The gradient of the tilt portion 14B is not specifically limited, and is preferably substantially uniform. The gradient of the tilt portion 14B can be adjusted depending on the viscosity of the electrode active material layer paste and conditions of fabrication apparatus.

The average thickness of the tilt portion 14B is smaller than the average thickness t₁ of the flat surface portion 14A. The tilt portion 14B has the length L4 in the long-side direction. The length L4 of the tilt portion 14B in the long-side direction is smaller than the length L3 of the flat surface portion 14A in the long-side direction in general. The length L4 of the tilt portion 14B in the long-side direction is set, but is not limited to, such that the length L1 of the electrode active material layer 14 in the long-side direction is 300 mm or more and 1400 mm or less and a length L2 from the uncoated portion 16 to a point P described later is 0.5 mm or more to 25 mm or less. For example, the length L4 of the tilt portion 14B in the long-side direction may be about 1 mm or more and 50 mm or less.

In the electrode disclosed here, the thickness of the tilt portion 14B in P is 0.8 of the average thickness t₁ of the flat surface portion 14A. That is, when the thickness of the tilt potion 14B at the point P is t₂, t₂=0.8×t₁. From the viewpoint of durability (capacity retention rate) of the secondary battery, the length L2 from the boundary between the electrode active material layer 14 (more specifically the tilt portion 14B) and the uncoated portion 16 to the point P in the long-side direction is preferably 0.5 mm or more, more preferably 1 mm or more, and much more preferably 10 mm or more. From the viewpoint of volumetric efficiency of the electrode (volume of the electrode opposed portion to the secondary battery), the length L2 from the uncoated portion 16 to the point P is preferably 30 mm or less, more preferably 25 mm or less, and much more preferably 20 mm or less. By adjusting the length L2 from the uncoated portion 16 to the point P within this range, both durability and volumetric efficiency of the secondary battery can be achieved.

Although it is not intended to limit the technique disclosed here, enhancement of durability of the secondary battery is supposed to be because of the following reasons. In a general secondary battery, carriers are absorbed and desorbed between the positive and negative electrodes and the electrolyte, and the resulting electrochemical reaction achieves charging and discharging. At this time, charges generated by desorption of electrolyte ions from the electrode active material move toward the electrode terminals in the electrode active material layer and the electrode current collector and then are taken out to an external load. Here, the density (i.e., current density) of charges moving in the electrode active material layer and the electrode current collector varies in the electrode body. Typically, the current density is relatively high near the electrode terminals (i.e., end portions), and is relatively low in portions away from the electrode terminals (i.e., the center portion). In particular, in the case where the electrode active material layer is long, as in the electrode disclosed here, variations of the current density are conspicuous between the center portion of the electrode body and the end portions. Accordingly, local degradation due to lithium precipitation occurs in part of the electrode, especially an end portion, so that durability (capacity retention rate) of the entire secondary battery decreases.

On the other hand, in the technique disclosed here, the electrode active material layer of at least 300 mm or more includes the flat surface portion and the tilt portion, and the length L2 between the uncoated portion and the point P at which the thickness of the tilt portion is 0.8 of the average thickness t₁ of the flat surface portion is 0.5 mm or more and 25 mm or less. In an end portion having a high current density, since the thin region is formed to be longer than that in a conventional structure, the volume ratio (negative electrode capacity/positive electrode capacity) in the end portion is higher than that in the center portion during charging so that lithium precipitation on the negative electrode can be suppressed. Similarly, during discharging, lithium ions desorbed from the negative electrode are appropriately absorbed in the positive electrode so that lithium precipitation on the positive electrode can he suppressed. Accordingly, durability (capacity retention rate) of the secondary battery is enhanced.

The volumetric efficiency of the secondary battery increases as the length L2 from the uncoated portion 16 to the point P decreases. A result of an intensive study of the inventor of the present disclosure shows that the volumetric efficiency is preferably 80 vol % or more and more preferably 85 vol % or more. Within this range, the volumetric efficiency is higher than that of a conventional small secondary battery, and a target energy amount can be achieved.

The electrode 10 can be fabricated in, for example, the following manner.

First, a material such as an electrode active material is dispersed in an appropriate solvent (e.g., N-methylpyrrolidone or water), thereby preparing an electrode active material layer paste. The paste is prepared with an agitating/mixing apparatus such as a. planetary mixer, a ball mill, a roll mill, a diaper, or a kneader. The electrode active material layer paste has a solid content concentration of, for example, preferably 40% by mass or more and 89% by mass or less.

A viscosity V1 of the electrode active material layer paste is preferably adjusted to be approximately 2000 mPa·s or more and 34000 mPa·s or less, typically 3000 mPa·s or more and 33000 mPa·s or less, for example, 5000 mPa·s or more and 33000 mPa·s or less. The viscosity V1 can be adjusted by changing the additive amount of a solid material (e.g., binder) to the solvent or a mixing/agitating time of the paste. By adjusting the viscosity V1 of the paste in a preferred range, the average thickness t₁ of the flat surface portion 14A of the electrode active material layer 14 and the length L2 between the point P and the uncoated portion can be appropriately adjusted.

The “viscosity” herein refers to a shearing viscosity (mPa·s), and can be easily measured with a commercially available rotational viscometer (famous type-B viscometer manufactured by Brookfield).

Next, the prepared electrode active material layer paste is applied onto the surface of the electrode current collector 12 except for an end portion of the electrode current collector 12 in the direction Y1. The paste is applied with a coating apparatus such as a die coater, a slit coater, a comma coater, or a gravure coater. In a preferred embodiment, a die coater including a conveyance mechanism that conveys the electrode current collector 12 along the long-side direction and a die head that discharges the electrode active material layer paste is prepared. The die head includes an ejection part that ejects the paste, and a feed valve and a return valve capable of switching supply of the paste. In applying the paste, the valve is switched to the feed valve so that the paste is supplied to the ejection part of the die head, and the paste is applied onto the electrode current collector 12. On the other hand, in stopping the application of the paste, the valve is switched to the return valve, and the paste is returned to a storage tank. The length L2 from the uncoated portion 16 of the electrode active material layer 14 to the point P may be adjusted by preadjusting the time difference in opening and closing the feed valve and the return valve. For example, the time difference in opening and closing the feed valve and the return valve may be adjusted within the range from 0 to 750 ms. The length L2 from the uncoated portion 16 to the point P of the electrode active material layer 14 can also be adjusted depending on a conveyance speed of the conveyance mechanism. For example, the conveyance speed is preferably adjusted to about 0.5 m/min or more and 20.0 m/min or less.

Then, the solvent is removed from the paste applied on the electrode current collector 12 by, for example, drying, thereby forming the electrode active material layer 14 on the electrode current collector 12. The method for drying may be any drying method conventionally used for secondary batteries of this type, without any particular limitation. For example, a heated-air dryer, a hot air dryer, or an infrared-air dryer can be used, for example. Drying conditions such as temperature and time of drying are preferably appropriately adjusted in consideration of, for example, the type and a solid content of a solvent used. The active material layer may be pressed in order to adjust the thickness and density, for example, of the electrode active material layer 14 formed on the electrode current collector 12. The method for pressing is not specifically limited, and is preferably performed with, for example, a mill roller or a flat-plate roller. In the manner described above, an electrode 10 including the electrode active material layer 14 having the flat surface portion 14A and the tilt portion 14B on the electrode current collector 12 is fabricated, as illustrated in FIG. 4.

A nonaqueous electrolyte secondary battery including the electrode 10 with the configuration described above can achieve both enhancement of durability and volumetric efficiency. Thus, with the characteristics describe above, the secondary battery can be suitably used as a driving power supply mounted on a vehicle such as a battery electric vehicle (BEV), a hybrid electric vehicle (HEV), and a plug-in hybrid electric vehicle (PHEV).

The box-shaped lithium ion secondary battery 100 including the laminated electrode body has been described as an example. Alternatively, the lithium ion secondary battery 100 may be configured as a lithium ion secondary battery including a wound electrode body. The outer shape of the lithium ion secondary battery may be cylindrical or laminated. The technique disclosed here is also applicable to nonaqueous electrolyte secondary batteries other than the lithium ion secondary battery.

Test examples for the secondary battery disclosed here will now be described, but are not intended to limit the technique disclosed here to the test examples.

<Production of Positive Electrode Sheet>

### EXAMPLE 1

First, LiMn₂O₄ as a positive electrode active material, acetylene black (AB) as a conductive material, and polyvinylidene fluoride (PVdF) as a binder were mixed with N-methylpyrrolidone (NMP) as a solvent by using a planetary mixer such that the mass ratio of these materials was 92:4:4, thereby preparing a positive electrode active material layer paste. Next, rectangular aluminium foil as a positive electrode current collector was prepared. The positive electrode active material layer paste was applied onto both surfaces of a positive electrode current collector (aluminium foil) with a die coater, and dried, thereby producing a positive electrode sheet. The application of the paste was performed along the long-side direction of the positive electrode current collector except for an uncoated portion where the positive electrode active material layer was not provided on an end portion of the long-side direction of the current collector. The positive electrode active material layer had a flat surface portion and a tilt portion and was applied to have an average thickness of the flat surface portion of 100 μm.

In Example 1, a point at which the length L1 of the positive electrode active material layer in the long-side direction was 300 mm. The position where the thickness of the tilt portion was 0.8 of the average thickness of the flat surface portion was defined as a point P. And application was performed such that the length L2 from the uncoated portion of the positive electrode current collector to the point P was 0.2 mm. The length L1 of the positive electrode active material layer in the long-side direction and the length L2 from the uncoated portion to the point P were adjusted depending on the viscosity and conveyance speed of the positive electrode active material layer paste. In Example 1, the positive electrode active material layer paste had a viscosity of 35000 mPa·s and a conveyance speed of 0.5 m/min. The viscosity is a value measured at 25° C. with a rheometer at a shearing speed of 21.5 s⁻¹.

### EXAMPLES 2 TO 7

The viscosity and conveyance speed of the positive electrode active material layer paste were adjusted such that the length L1 of the positive electrode active material layer in the long-side direction was 300 mm and the length L2 from the uncoated portion to the point P is the lengths shown in Table 1. Except for this, positive electrode sheets of Example 2 to 7 were fabricated in the same manner as Example 1.

Specifically, in Example 2, the viscosity of the positive electrode active material layer paste was adjusted to 33000 mPa·s, and the conveyance speed thereof was adjusted to 0.5 m/min.

In Example 3, the viscosity of the positive electrode active material layer paste was adjusted to 30000 mPa·s, and the conveyance speed thereof was adjusted to 0.7 m/min.

In Example 4, thereof was adjusted to 20000 mPa·s, and the conveyance speed thereof was adjusted to 1.5 m/min.

In Example 5, the viscosity of the positive electrode active material layer paste was adjusted to 15000 mPa·s, and the conveyance speed thereof was adjusted to 2.0 m/min.

In Example 6, the viscosity of the positive electrode active material layer paste was adjusted to 5000 mPa·s, and the conveyance speed thereof was adjusted to 10.0 m/min.

In Example 7, the viscosity of the positive electrode active material layer paste was adjusted to 2000 mPa·s, and the conveyance speed thereof was adjusted to 20.0 m/min.

### EXAMPLES 11 TO 17 AND EXAMPLES 21 TO 27

The viscosity and conveyance speed of the positive electrode active material layer paste were adjusted such that the length L1 of the positive electrode active material layer in the long-side direction was 625 mm and the length L2 from the uncoated portion to the point P is the lengths shown in Table 1. Except for this, positive electrode sheets of Example 11 to 17 were fabricated in the same manner as Example 1. The viscosity and conveyance speed of the positive electrode active material layer paste were adjusted such that the length L1 of the positive electrode active material layer in the long-side direction was 1400 mm and the length L2 from the uncoated portion to the point P is the lengths shown in Table 1. Except for this, positive electrode sheets of Example 21 to 27 were fabricated in the same manner as Example 1.

Specifically, Examples 11 and 21, the viscosity of the positive electrode active material layer paste was adjusted to 35000 mPa·s, and the conveyance speed thereof was adjusted to 0.5 m/min.

In Examples 12 and 22, the viscosity of the positive electrode active material layer paste was adjusted to 33000 mPa·s, and the conveyance speed thereof was adjusted to 0.5 m/min.

In Examples 13 and 23 the viscosity of the positive electrode active material layer paste was adjusted to 30000 mPa·s, and the conveyance speed thereof was adjusted to 0.7 m/min.

In Examples 14 and 24, the viscosity of the positive electrode active material layer paste was adjusted to 20000 mPa·s, and the conveyance speed thereof was adjusted to 1.5 m/min.

In Examples 15 and 25, the viscosity of the positive electrode active material layer paste was adjusted to 15000 mPa·s, and the conveyance speed thereof was adjusted to 2.0 m/min.

In Examples 16 and 26, the viscosity of the positive electrode active material layer paste was adjusted to 5000 mPa·s, and the conveyance speed thereof was adjusted to 10.0 m/min.

In Examples 17 and 27, the viscosity of the positive electrode active material layer paste was adjusted to 2000 mPa·s, and the conveyance speed thereof was adjusted to 20.0 m/min.

### REFERENCE EXAMPLE

As a reference example, an electrode included in a conventional secondary battery was fabricated. Specifically, in a manner similar to Example 1, a positive electrode sheet was produced such that the length L1 of the positive electrode active material layer in the long-side direction was 250 mm and the length L2 from the uncoated portion to the point P was 0.2 mm.

<Production of Lithium Ion Secondary Battery for Evaluation>

First, natural graphite (C) as a negative electrode active material, styrene butadiene rubber (SBR) as a binder, and carboxymethyl cellulose (CMC) as a thickener were mixed with ion-exchanged water as a solvent by using a planetary mixer such that a mass ratio of these materials was 98:1:1, thereby preparing a negative electrode active material layer paste. Next, rectangular copper foil was prepared as a negative electrode current collector. The negative electrode active material layer paste was applied onto both surfaces of a negative electrode current collector (copper foil) with a die coater, and dried, thereby producing a negative electrode sheet. The application of the paste was performed along the long-side direction of the negative electrode current collector except for an uncoated portion where the negative electrode active material layer is not provided on an end portion of the current collector.

As a separator, a single-layer porous sheet (thickness: 17 μm) of polyethylene (PE) was prepared.

The positive electrode sheet and the negative electrode sheet produced were stacked with the separator interposed therebetween. At this time, the sheets were cut such that a phase difference between the positive electrode and the negative electrode and a phase difference between the negative electrode and the separator was 1.5 mm. Next, electrode terminals of the same pole type were connected to the positive electrode current collector uncoated portion and the negative electrode current collector uncoated portion of the electrode body. This electrode body were sandwiched by two laminated films, and peripheral portions thereof are heat-welded. After injection of a nonaqueous electrolyte, sealing was performed, thereby producing a lithium ion secondary battery for evaluation. As the nonaqueous electrolyte, an electrolyte was prepared by dissolving LiPF₆ as a supporting electrolyte in a mixed solvent including ethylene carbonate (EC), dimethyl carbonate (DMC), and ethyl methyl carbonate (EMC) at a volume ratio of 30:30:40 at a concentration of 1 mol/L.

<Calculation of Volumetric Efficiency>

A volumetric efficiency of the evaluation lithium ion secondary battery of each of the examples produced as described above was calculated. The volumetric efficiency (vol %) was calculated by: volumetric efficiency (vol %)=(volume of positive electrode opposed portion/volume of entire secondary battery)×100. Table 1 shows the results.

In the evaluation, volumetric efficiencies of 85 vol % or more are represented as “A,” volumetric efficiencies of 80 Vol % or more are represented as “B,” and volumetric efficiencies less than 80 Vol % are represented as “C.” Table 1 shows the results.

<Measurement of Temperature Difference of Secondary Battery>

The evaluation lithium ion secondary battery of each of the examples described above was subjected to initial charging and discharging. Thereafter, charging was performed with a constant current of 1.5 C, and temperatures of the secondary battery in the center portion and the end portion (electrode terminal) after 30 minutes were measured with a thermometer in a non-contact manner. At this time, if the temperature difference between the center portion and the end portion of the secondary battery is within 20° C., it is evaluated that variations in current density are suppressed between the end portion and the center portion. Table 1 shows the results.

In Table 1, “1 C” refers to a current value enabling charging of a battery capacity (Ah) expected from the theoretical capacity of the positive electrode active material in one hour.

<Post-Cycle Capacity Retention Rate>

Under a temperature condition of 25° C., the evaluation lithium ion secondary battery of each example was subjected to constant-current charging (CC charging) with a current value of 1 C to an SOC of 95%, and then to constant-current discharging (CC discharging) with a constant current of 1.0 C to an SOC of 5%, and a discharge capacity at the CC discharging was defined as an initial capacity. Next, under 25° C., CC charging was performed with a current value of 1 C to an SOC of 95%, and then, CC discharging was performed with a current value of 1.0 C to an SOC of 5%. This process was defined as one cycle, and 100 cycles were performed. The discharge capacity at the 100th cycle was defined as a post-cycle capacity, and the post-cycle capacity was obtained in the same manner as the initial capacity. As an index of durability, a capacity retention rate (%) was obtained by: capacity retention rate (%)=(post-cycle capacity/initial capacity)×100. Table 1 shows the results.

TABLE 1

| | | | Volumetric Efficiency | | Battery Temperature | | | Post-cycle |
|---|---|---|---|---|---|---|---|---|
| | Length | Length | Volumetric | | | | Temperature | Capacity |
| | L1 | L2 | Efficiency | | End | Center | Difference | Retention |
| | (mm) | (mm) | (vol %) | Evaluation | (° C.) | (° C.) | (° C.) | Rate (%) |
| Example 1 | 300 | 0.2 | 91.5 | A | 57 | 26 | 31 | 79 |
| Example 2 | 300 | 0.5 | 91.3 | A | 44 | 26 | 18 | 88 |
| Example 3 | 300 | 1.0 | 91.1 | A | 42 | 26 | 16 | 89 |
| Example 4 | 300 | 10.0 | 88.0 | A | 41 | 26 | 15 | 90 |
| Example 5 | 300 | 15.0 | 86.0 | A | 39 | 26 | 13 | 91 |
| Example 6 | 300 | 25.0 | 85.0 | A | 37 | 26 | 11 | 93 |
| Example 7 | 300 | 30.0 | 83.0 | B | 37 | 26 | 11 | 93 |
| Example 11 | 625 | 0.2 | 91.5 | A | 57 | 26 | 31 | 79 |
| Example 12 | 625 | 0.5 | 91.3 | A | 44 | 26 | 18 | 88 |
| Example 13 | 625 | 1.0 | 91.1 | A | 42 | 26 | 16 | 89 |
| Example 14 | 625 | 10.0 | 88.0 | A | 41 | 26 | 15 | 90 |
| Example 15 | 625 | 15.0 | 86.0 | A | 39 | 26 | 13 | 91 |
| Example 16 | 625 | 25.0 | 85.0 | A | 37 | 26 | 11 | 93 |
| Example 17 | 625 | 30.0 | 83.0 | B | 37 | 26 | 11 | 93 |
| Example 21 | 1400 | 0.2 | 92.8 | A | 55 | 26 | 29 | 81 |
| Example 22 | 1400 | 0.5 | 92.5 | A | 46 | 26 | 20 | 87 |
| Example 23 | 1400 | 1.0 | 92.0 | A | 46 | 26 | 20 | 87 |
| Example 24 | 1400 | 10.0 | 89.0 | A | 45 | 26 | 19 | 87 |
| Example 25 | 1400 | 15.0 | 87.0 | A | 45 | 26 | 19 | 87 |
| Example 26 | 1400 | 25.0 | 85.0 | A | 45 | 26 | 19 | 87 |
| Example 27 | 1400 | 30.0 | 83.0 | B | 45 | 26 | 19 | 87 |
| Reference Example | 250 | 0.2 | 79.0 | C | 37 | 26 | 11 | 93 |

As shown in Table 1, from the viewpoint of the capacity retention rate, in Examples 1 to 7 in which the length L1 of the electrode active material layer in the long-side direction is 300 mm and Examples 11 to 17 in which the length L1 is 625 mm, the length L2 from the uncoated portion to the point P is preferably 0.5 mm or more, and especially in a case where the length L2 from the uncoated portion to the point P is 10 mm or more, the capacity retention rate exceeds 90%, and a high capacity retention rate is obtained. On the other hand, from the viewpoint of volumetric efficiency, if the length L2 from the uncoated portion to the point P is 25 mm or less, a volumetric efficiency of 85 vol % or more is achieved, and as the length L2 from the uncoated portion to the point P decreases, the volumetric efficiency increases.

Thus, in consideration of both the capacity retention rate and the volumetric efficiency, the length L2 from the uncoated portion to the point P is preferably 0.5 mm or more and 25 mm or less, and more preferably 1 mm or more and 25 mm or less.

Table 1 shows that in Examples 21 to 27 that are especially elongated secondary batteries in which the length L1 of the electrode active material layer in the long-side direction is 1400 mm, from the viewpoint of the capacity retention rate, the length L2 from the uncoated portion to the point P only needs to be 0.5 mm or more. On the other hand, from the viewpoint of volumetric efficiency, if the length L2 from the uncoated portion to the point P is 25 mm or less, a volumetric efficiency of 85 vol % or more is achieved, and as the length L2 from the uncoated portion to the point P decreases, the volumetric efficiency increases.

Thus, in consideration of both the capacity retention rate and the volumetric efficiency, the length L2 from the uncoated portion to the point P is preferably 0.5 mm or more and 25 mm or less.

From the results described above, the secondary battery in which the length L1 of the electrode active material layer in the long-side direction is 300 mm or more, the electrode active material layer includes the flat surface portion and the tilt portion, and the length L2 from the boundary between the electrode active material layer and the uncoated portion to the point P is 0.5 mm or more and 25 mm or less is a secondary battery showing enhanced durability and volumetric efficiency.

Specific examples of the present disclosure have been described in detail hereinbefore, but are merely illustrative examples, and are not intended to limit the scope of claims.

The techniques described in claims include various modifications and changes of the above exemplified specific examples.

What is claimed is:

1. A secondary battery electrode that is a positive electrode or a negative electrode of a secondary battery, the secondary battery electrode comprising:
a rectangular sheet-like electrode current collector; and
an electrode active material layer disposed on the electrode current collector, wherein
at least one end portion of the electrode current collector in a long-side direction is provide with an uncoated portion in which the electrode active material layer is not formed,
the electrode active material layer has a length L1 of 300 mm or more in the long-side direction, and includes a flat surface portion having a substantially uniform average thickness t₁ and a tilt portion in which the tilt portion having a thickness that continuously decreases toward the uncoated portion, and
a length L2 from a boundary between the electrode active material layer and the uncoated portion to a point P is 0.5 mm or more and 25 mm or less, where P is a point at which the thickness of the tilt portion is 0.8 of the average thickness t₁ of the flat surface portion.

2. The secondary battery electrode according to claim 1, wherein the length L1 of the electrode active material layer in the long-side direction is 600 mm or more and 1400 mm or less.

3. A nonaqueous electrolyte secondary battery comprising:
a positive electrode;
a negative electrode; and
a nonaqueous electrolyte, wherein
at least one of the positive electrode or the negative electrode is the electrode as claimed in claim 1.
